(19) United States
(12) Patent Application Publication
(10) Pub. No.: US 2004/0205491 A1
(43) Pub. Date: Oct. 14, 2004

(54) Software and method for self-service applications

(76) Inventors: Aravinda Korala, Edinburgh (GB); David Busvine, Edinburgh (GB)

Correspondence Address: SALTAMAR INNOVATIONS, 30 FERN LANE, SOUTH PORTLAND, ME, 04106, US

(21) Appl. No.: 09/870,293

(22) Filed: May 30, 2001

(51) Int. Cl. G06F 15/00

(52) U.S. Cl. 715/501.1; 345/760

(57) ABSTRACT

Software architecture comprising site agent components, browser components, transaction device driver components and user interface components, contained within the same object model, for customising self-service kiosk functionality in response to the download of web pages. One of several site agents components can be selected by a user and site agents can act to alter web sites, display alternative content and drive remote web sites.

### FIELD OF THE INVENTION

The present invention relates to the field of web-enabled self-service kiosks such as automated teller machines, ticketing machines, vending machines, web kiosks and internet enabled interactive television set-top boxes with user interface peripherals.

### BACKGROUND

Within this specification, self-service kiosks are networked computing devices designed for use by multiple users to carry out self-contained operations. Examples of kiosks are automatic teller machines (ATMs), public internet access terminals, credit-card operated and/or prepaid ticket collection terminals, networked ticketing machines and computerised vending machines as these are designed for use by multiple users and each user's interaction with the kiosk is a separate self-contained session. Home computers are not kiosks because users make open-ended changes to such computers; however, they can emulate kiosks and personal computers can also control kiosks. The present invention can also be applied to interactive televisions having the facilities to emulate kiosks. These facilities would include user identifying means such as a smartcard reader.

Many different types of hardware and software are in common use on self-service kiosks. The lack of standardisation and the fact that self-service kiosks have different hardware and software configurations makes the delivery of web-enabled services through such kiosks difficult without extensive customisation of particular applications. Furthermore, many web applications are written for use on personal computers and so cannot be successfully delivered through kiosks which have different peripherals to those typically provided on a personal computer.

It is therefore desirable to provide a way of enabling web applications to be used on kiosks with different hardware and software configurations, preferably with minimum or no modification to the web application.

Many kiosks are provided in public places such as shops and malls and use internet access to provide links to a variety of external web sites. However, in these circumstances it is typically desired to ensure that users can only access a limited range of sites, for example those owned by a particular organisation. This is typically performed by a “web wrap” application, of which several are known in the art, which allows access only to certain URLs.

One method for enabling a kiosk to provide access to a standard web application is described WO99/49431 to Korala Associates Ltd. In this application, a downloaded web site may be modified by magnifying hyperlinks or other regions which will not display correctly or which are too small to operate with a touch screen when displayed on a kiosk.

U.S. Pat. No. 5,761,071 to Lexitech, Inc. describes a method for blocking access to disallowed browser functionality by displaying at least one image on the screen which masks disallowed controls.

U.S. Pat. No. 6,188,401 to Microsoft Corporation describes a computer program for use in the field of interactive television which contains a global script file exposing methods and properties available to hypertext content downloaded from a network. The global script file can be edited by vendors to customise the appearance and other user interface elements.

### BRIEF DESCRIPTIONS OF THE INVENTION

According to a first aspect of the present invention there is provided a control program comprising:

a document retrieving module for retrieving hyperlinked documents, the documents comprising graphical image data and/or instructions;

at least one document altering module adapted to alter an accessed document responsive to accessing of said document;

a document executing module for rendering a visual display and/or executing instructions according to said altered document;

wherein said control program is controlling at least part of the operation of a self-service kiosk.

Preferably, the hyperlinked documents are web pages. This invention therefore allows downloaded web pages to be altered before they are rendered. Not only does this allow kiosk providers to present customised web content but it enables them to do so without having to alter conventional web pages at source. Web pages might be altered to add or delete content, including instructions to hardware peripherals provided on the kiosk. Additional functions can also be carried out.

The control program may further comprise a plurality of document content alteration directives, each having at least one activation condition associated therewith; wherein the document altering module is adapted to alter said document responsive to one or more of said document content alteration directives when at least one activation condition is fulfilled.

Preferably, the activation conditions are selected from a group consisting of downloading of a page with a specified URL, downloading of a page containing a specific script, text segment, tag or meta-tag, a predetermined amount of time having passed, an event generated by the container, an event generated by a site agent, a user-input event.

Preferably, the control program is adapted to selectively activate one or more document altering modules, said document altering modules only altering documents once the document altering module is activated.

More preferably, the control program is adapted to notify a document altering module when a document has been retrieved and thereby cause the document altering module to alter the document.

A document altering module may be adapted to add, remove or change instructions in the document which, when executed by the document executing module, cause the computer to perform an action selected from a group consisting of:

access a user interface hardware device;

send information to a remote server across a network;

receive information from a remote server across a network; or receive authorisation to allow a transaction from a transaction authorising server.

A document altering module may comprise program code to cause the computer to perform an action selected from a group consisting of:

access a user interface hardware device;

send information to a remote server across a network;

receive information from a remote server across a network; or receive authorisation to allow a transaction from a transaction authorising server.

A document altering module may alter a document to prevent a function being executed until at least one specified event has occurred. A document may be altered to disable a button until at least one specified event has occurred.

A document may be altered to disable a hyperlink to another document until at least one specified event has occurred. A specified event is typically the receipt of specified information from a server. A specified event may be the receipt of specified information from a server indicating the user has completed a transaction. Specified information from a server may be a particular web page or a web page comprising particular information.

The control program may be adapted to direct one or more browser components to retrieve addressed documents which direct a user to carry out a particular action responsive to which a server transmits the specified information.

The control program may be adapted to access a list of addressed documents and to alter each addressed document to only link to other documents on said list, wherein the control program detects a user access to each addressed document on said list and carries out a predetermined function responsive to at least said detection. Preferably, the function responsive to said detection is retrieval of a specified document.

The control program may further comprise one or more transaction components providing methods for carrying out a hardware function.

Preferably, a document is a web page. The document retrieving module and the document executing module are preferably both part of a web browser. The control program is preferably adapted to parse a downloaded web page into a document object model, wherein the document altering module alters the document object model. A document retrieving module, a web browser and a downloaded web page document object model preferably expose methods and properties which are part of a single object model.

A document altering module may be adapted to display a different image or execute different instructions to the web page. The document altering module may display a different image by a browser component overlaying an alternative image over a displayed web page or by displaying the retrieved web page and also additional visual elements. Additional visual elements preferably comprise branding.

A plurality of document altering modules may alter an accessed document.

The control program may be adapted to add branding to one or more web pages and this may take place after a user has visited one or more specified web pages.

A document altering module is preferably activated in response to a user visiting a web page or one of a plurality of web pages and the document altering module alters subsequently retrieved web pages. Specified subsequent web pages may be altered.

According to a second aspect of the present invention there is provided a method of implementing a user interface on a self-service kiosk in conjunction with hyperlinked documents retrievable from a data store, the documents comprising renderable display information and/or executable instructions, the invention comprising the steps of:

retrieving a document from a data store;

calling a document altering module which alters the document;

rendering and/or executing the document.

The document altering module may be adapted to alter said document responsive to one or more web content alteration directives when at least one activation condition is fulfilled, said one or more web content alteration directives being selected from a plurality of web content alteration directives, each having at least one activation condition associated therewith

The activation conditions are preferably selected from a group consisting of downloading of a page with a specified URL, downloading of a page containing a specific script, text segment, tag or meta-tag, a predetermined amount of time having passed, an event generated by the container, an event generated by a site agent, a user-input event.

The method preferably comprises the step of selectively activating one or more document altering modules, said document altering modules only altering documents once activated. Preferably also, the method further comprises the step of notifying a document altering module when a document has been retrieved and thereby causing the document altering module to alter the document.

A document altering module may be adapted to add, remove or change instructions in the document which, when executed by the document executing module, cause the computer to do at least one of:

access a user interface hardware device;

send information to a remote server across a network;

receive information from a remote server across a network; or receive authorisation to allow a transaction from a transaction authorising server.

A document altering module may comprise program code to cause the computer to do at least one of:

access a user interface hardware device;

send information to a remote server across a network;

receive information from a remote server across a network; or receive authorisation to allow a transaction from a transaction authorising server.

A document altering module may alter document to prevent a function being executed until at least one specified event has occurred. A document may be altered to disable a button until at least one specified event has occurred. A document may be altered to disable a hyperlink to another document until at least one specified event has occurred. A specified event is preferably the receipt of specified information from a server. Typically, this is the receipt of specified information from a server indicating the user has completed a transaction. Specified information from a server may be a particular web page or a web page comprising particular information. The method may further comprise the step of directing one or more browser components to retrieve addressed documents which direct a user to carry out a particular action responsive to which a server transmits the specified information.

The method may further comprise the steps of:

establishing a list of addressed documents;

the document altering module altering each addressed document to only link to other documents on that list; and

carrying out a function responsive to detection that the user has accessed each addressed document in the list.

Preferably, the function responsive to said detection is retrieval of a specified document.

The method may further comprise the step of providing one or more transaction components providing methods for carrying out a hardware function.

Preferably, a document is a web page. Preferably also, the document retrieving module and the document executing module are both part of a web browser. Preferably, the method includes parsing a downloaded web page into a document object model and the document altering module altering the document object model. Preferably also, a document retrieving module, a web browser and a downloaded web page document object model expose methods and properties which are part of a single object model.

A document altering module may display a different image or execute different instructions to the web page. The document altering module may display a different image by a browser component overlaying an alternative image over a displayed web page. Alternatively, the document altering module displays a different image by displaying the retrieved web page and also additional visual elements, for example branding.

Multiple document altering modules may alter an accessed document.

Branding may be added to one or more web pages and the method may comprise the step of adding branding to one or more web pages after a user has visited one or more specified web pages.

A document altering module may be activated in response to a user visiting a web page or one of a plurality of web pages and alters subsequently retrieved web pages, preferably specified subsequent web pages.

According to a third aspect of the present invention there is provided a computer readable media having the computer program of the first aspect stored thereon.

According to a fourth aspect of the present invention there is provided a computer readable media comprising computer program code means which, when loaded onto a computer, cause it to execute the method of the second aspect.

According to a fifth aspect of the present invention there is provided a control program comprising:

a document retrieving module for retrieving hyperlinked documents, the documents comprising graphical image data and/or instructions;

a document executing module for rendering a visual display and/or executing instructions according to said document; and

at least one agent module responsive to retrieving of said document;

wherein said control program is controlling at least part of the operation of a self-service kiosk.

Preferably, the program further comprises a plurality of directives, each having at least one activation condition associated therewith; wherein an agent module is adapted to execute one or more functions responsive to one or more of said directives when at least one activation condition is fulfilled.

The activation conditions are preferably selected from a group consisting of downloading of a page with a specified URL, downloading of a page containing a specific script, text segment, tag or meta-tag, a predetermined amount of time having passed, an event generated by the container, an event generated by a site agent, a user-input event.

The program is preferably adapted to selectively activate one or more agent modules, said agent modules only operable responsive to retrieval of documents once activated. Preferably, the program notifies an agent module when a document has been retrieved.

An agent module may be adapted to:

access a user interface hardware device;

send information to a remote server across a network;

receive information from a remote server across a network; or receive authorisation to allow a transaction from a transaction authorising server.

An agent module may be adapted to carry out a function when at least one specified event has occurred. A specified event may be the receipt of specified information from a server. A specified event may be the receipt of specified information from a server indicating the user has completed a transaction. Specified information from a server may be a particular document or a document comprising particular information.

The program may be adapted to direct one or more browser components to retrieve addressed documents which direct a user to carry out a particular action responsive to which the specified event occurs. The specified event may be detection that the user has viewed and/or accessed each of a plurality of specified documents. An agent module may be adapted to activate and instruct one or more separate browser components.

One or more transaction components providing methods for carrying out a hardware function.

Preferably, a document is a web page. Preferably also, the document retrieving module and the document executing module are both part of a web browser. More preferably, a document retrieving module, a web browser and a downloaded web page document object model expose methods and properties which are part of a single object model.

An agent module is adapted to display a different image or execute different instructions to the web page. The document altering module may display a different image by a browser component overlaying an alternative image over a displayed web page.

An agent module may cause one or more further software components to be activated.

Further software components may provide visual images, preferably branding.

An agent module may be activated in response to a user visiting a web page or one of a plurality of web pages and carry out functions responsive to retrieval of subsequent web pages. Preferably, the program is responsive to retrieval of specified subsequent web pages.

According to a sixth aspect of the present invention there is provided a method of implementing a user interface on a self-service kiosk in conjunction with hyperlinked documents retrievable from a data store, the documents comprising renderable display information and/or executable instructions, the method comprising the steps of:

retrieving a document from a data store;

activating an agent module responsive to retrieval of the document; and

rendering and/or executing the document.

An agent module may execute one or more functions responsive to one or more directives when at least one activation condition is fulfilled, said one or more directives being from a plurality of directives, each having at least one activation condition associated therewith. Preferably, the activation conditions are selected from a group consisting of downloading of a page with a specified URL, downloading of a page containing a specific script, text segment, tag or meta-tag, a predetermined amount of time having passed, an event generated by the container, an event generated by a site agent, a user-input event.

The method may comprise the step of selectively activating one or more agent modules, said agent modules operable responsive to retrieval of documents once activated. An agent module is preferably notified when a document has been retrieved.

An agent module may:

access a user interface hardware device;

send information to a remote server across a network;

receive information from a remote server across a network; or receive authorisation to allow a transaction from a transaction authorising server.

An agent module may be adapted to carry out a function when at least one specified event has occurred. Preferably, a specified event is the receipt of specified information from a server. More preferably, a specified event is the receipt of specified information from a server indicating the user has completed a transaction. Specified information from a server may be a particular document or a document comprising particular information.

The program may be adapted to direct one or more browser components to retrieve addressed documents which direct a user to carry out a particular action responsive to which the specified event occurs. The specified event may be detection that the user has viewed and/or accessed each of a plurality of specified documents.

An agent module preferably activates and instructs one or more separate browser components. Preferably, the method further comprises the step of activating one or more transaction components providing methods for carrying out a hardware function.

Preferably, a document is a web page. The document retrieving module and the document executing module are preferably both part of a web browser. Preferably also, a document retrieving module, a web browser and a downloaded web page document object model expose methods and properties which are part of a single object model.

An agent module may display a different image or execute different instructions to the web page. Preferably, the document altering module displays a different image by a browser component overlaying an alternative image over a displayed web page. Preferably also, the agent module causes one or more further software components to be activated.

Preferably, further software components provide visual images, preferably branding.

An agent module may be activated in response to a user visiting a web page or one of a plurality of web pages and carries out functions responsive to retrieval of subsequently web pages. Preferably the module is responsive to retrieval of specified subsequent web pages.

According to a seventh aspect of the present invention there is provided a computer readable media having the control program of the fifth aspect stored thereon.

According to an eighth aspect of the present invention there is provided a computer readable media comprising computer program code means which, when loaded onto a self-service kiosk, cause it to execute the method of the sixth aspect.

According to a ninth aspect of the present invention there is provided a control program comprising:

a web page retrieving module for retrieving web pages;

at least one web page altering module adapted to alter a retrieved web page responsive to retrieval of said web page; and

a web page executing module for rendering said altered web page and executing any instructions in the altered web page;

wherein the document altering module is adapted to alter said web page responsive to one or more web content alteration directives when at least one activation condition is fulfilled;

wherein said control program is controlling at least part of the operation of a self-service kiosk.

According to a tenth aspect of the present invention there is provided a control program comprising:

a web page retrieving module for retrieving web pages;

at least one web page altering module adapted to alter a retrieved web page responsive to retrieval of said web page;

a web page executing module for rendering said altered web page and executing any instructions in the altered web page;

wherein the control program is adapted to selectively activate at least one web page altering module, said document altering modules only altering documents once activated;

wherein said control program is controlling at least part of the operation of a self-service kiosk.

According to an eleventh aspect of the present invention there is provided a control program comprising:

a web page retrieving module for retrieving web pages;

at least one web page altering module adapted to alter a retrieved web page responsive to retrieval of said web page;

a web page executing module for rendering said altered web page and executing any instructions in the altered web page;

wherein the control program is adapted to selectively activate at least one web page altering module, said document altering modules only altering documents once activated;

wherein at least one web page altering module is adapted to alter a retrieved web page to cause said web page executing module to access a user interface hardware device when said altered retrieved web page is rendered;

wherein said control program is controlling at least part of the operation of a self-service kiosk.

According to a twelfth aspect of the present invention there is provided a control program comprising:

a web page retrieving module for retrieving web pages;

at least one web page altering module adapted to alter a retrieved web page responsive to retrieval of said web page;

a web page executing module for rendering said altered web page and executing any instructions in the altered web page;

wherein the control program is adapted to selectively activate at least one web page altering module, said document altering modules only altering documents once activated;

wherein at least one web page altering module is adapted to alter a retrieved web page to cause said web page executing module to access a remote server when said altered retrieved web page is rendered;

wherein said control program is controlling at least part of the operation of a self-service kiosk.

According to a thirteenth aspect of the present invention there is provided a control program comprising:

a web page retrieving module for retrieving web pages;

at least one web page altering module adapted to alter a retrieved web page responsive to retrieval of said web page;

a web page executing module for rendering a visual display and executing any instructions in the altered web page;

wherein the control program is adapted to selectively activate at least one web page altering module, said document altering modules only altering documents once activated;

wherein at least one web page altering module is adapted to add branding to retrieved web page before said web page is executed;

wherein said control program is controlling at least part of the operation of a self-service kiosk.

According to a fourteenth aspect of the present invention there is provided a control program comprising:

a web page retrieving module for retrieving web pages;

at least one web page altering module adapted to alter a retrieved web page responsive to retrieval of said web page;

a web page executing module for rendering said altered web page and executing any instructions in the altered web page;

wherein the control program is adapted to selectively activate at least one web page altering module, said document altering modules only altering documents once activated;

wherein at least one web page altering module is adapted to display additional branding on the visual display;

wherein said control program is controlling at least part of the operation of a self-service kiosk.

According to a fifteenth aspect of the present invention there is provided a control program comprising:

a web page retrieving module for retrieving web pages;

at least one web page altering module adapted to alter a retrieved web page responsive to retrieval of said web page;

a web page executing module for rendering said altered web page and executing any instructions in the altered web page;

wherein the control program is adapted to selectively activate at least one web page altering module, said document altering modules only altering documents once activated;

wherein the control program is adapted to initially alter a web page to prevent a specified transaction being completed and to alter the web page to allow said transaction to be completed only when at least one other transaction has been completed;

wherein said control program is controlling at least part of the operation of a self-service kiosk.

An example embodiment of the present invention will now be discussed with reference to the following Figures in which:—

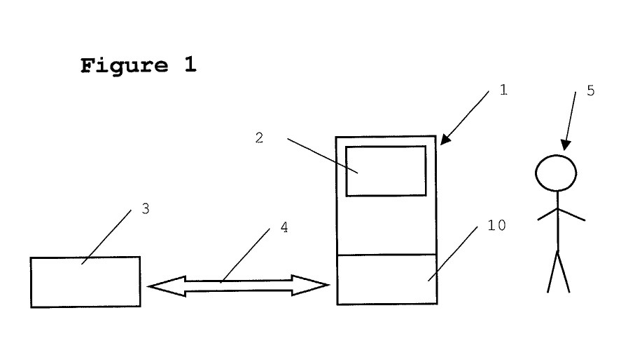

FIG. 1 is a schematic view of a kiosk;

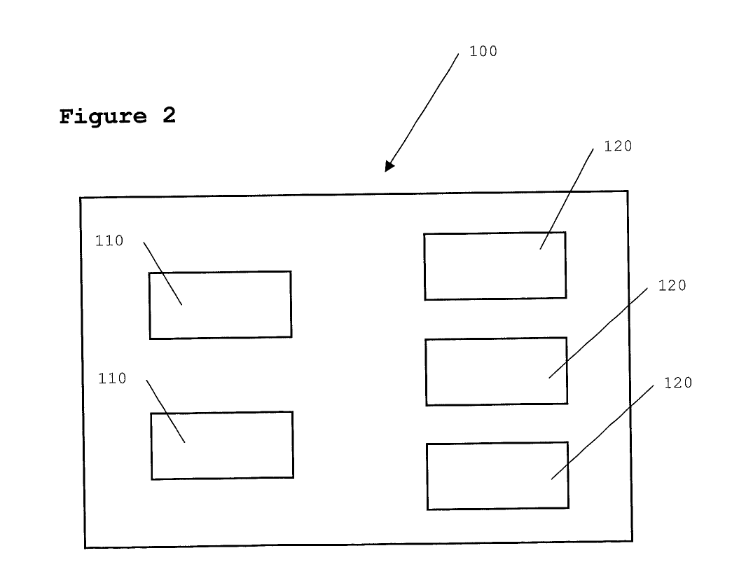

FIG. 2 is a schematic diagram of an architecture of a container software application;

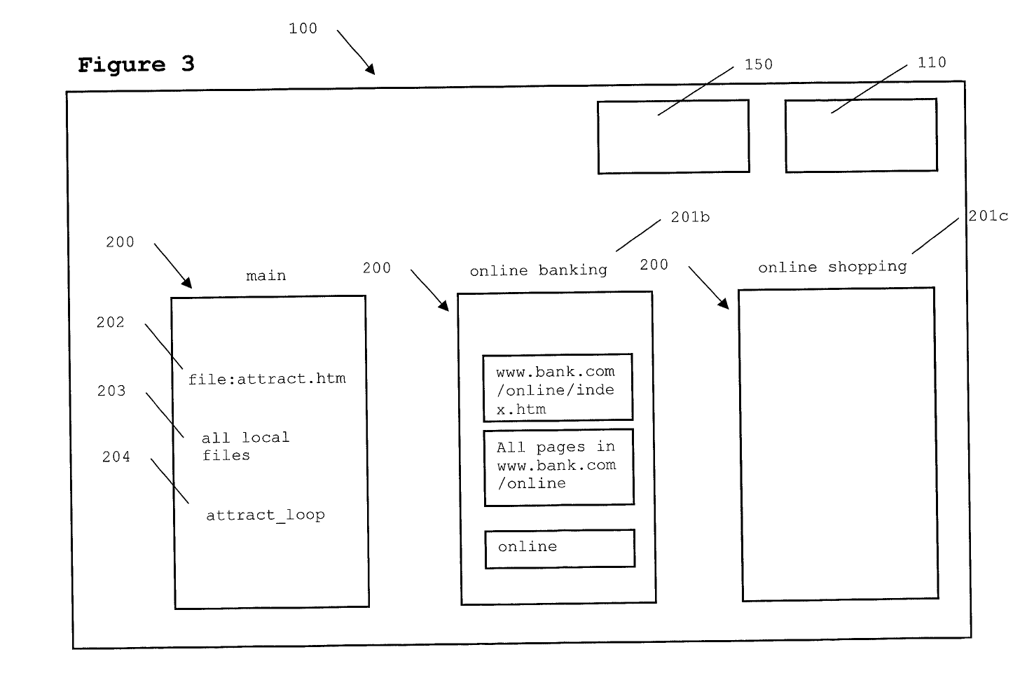

FIG. 3 is a schematic diagram of a siteset;

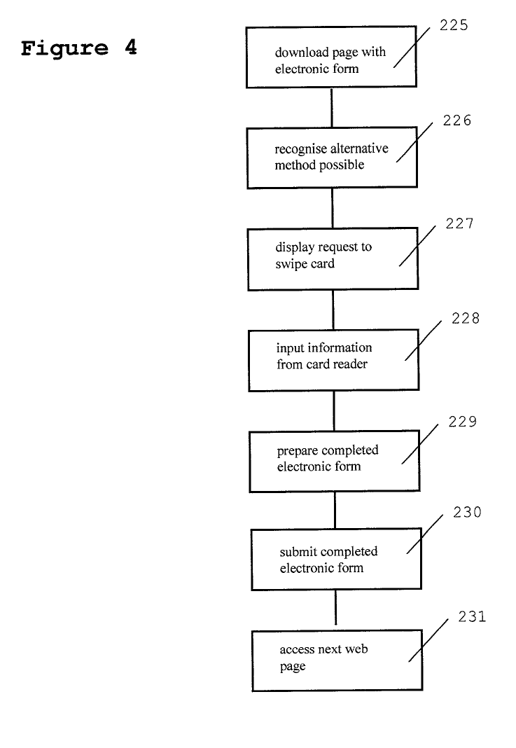

FIG. 4 is a flow chart showing steps in completing and submitting an electronic form using information read from a card reader;

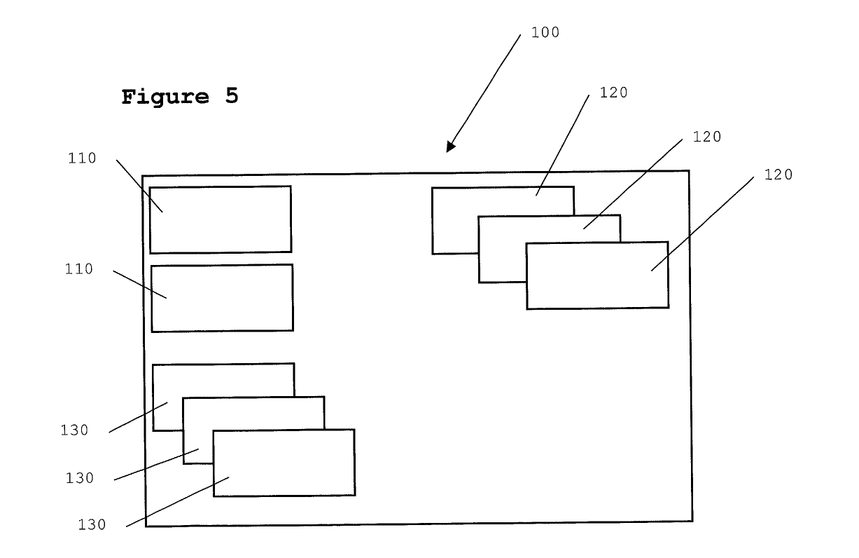

FIG. 5 is a schematic diagram of an architecture of an alternative container software application;

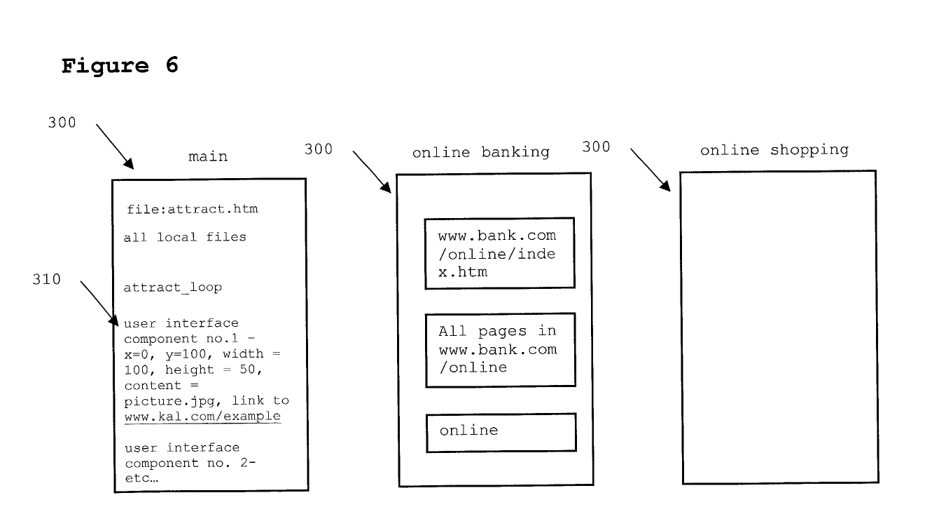

FIG. 6 is a schematic diagram of an alternative siteset;

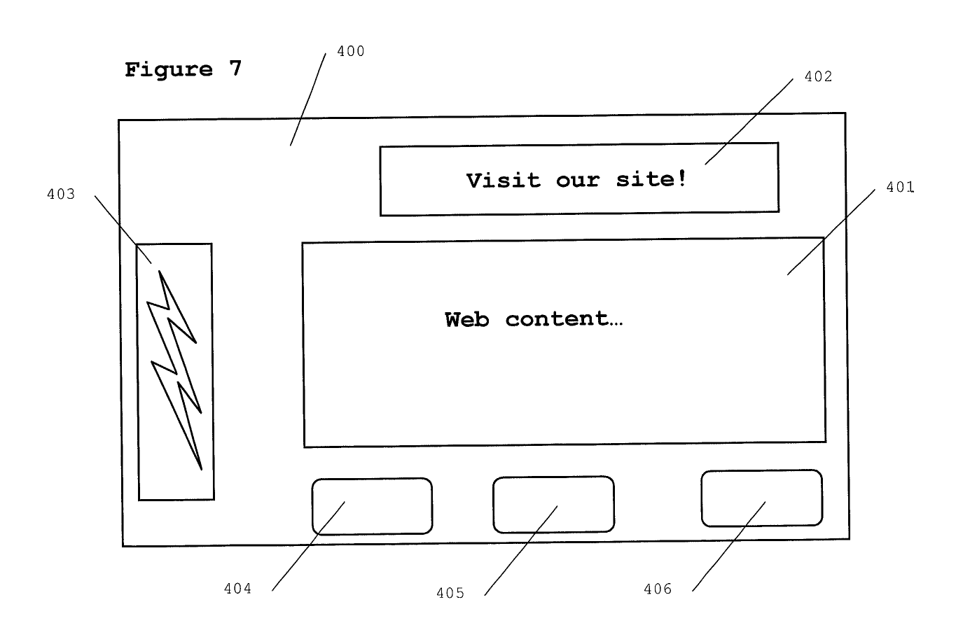

FIG. 7 represents a screen display of an example user interface;

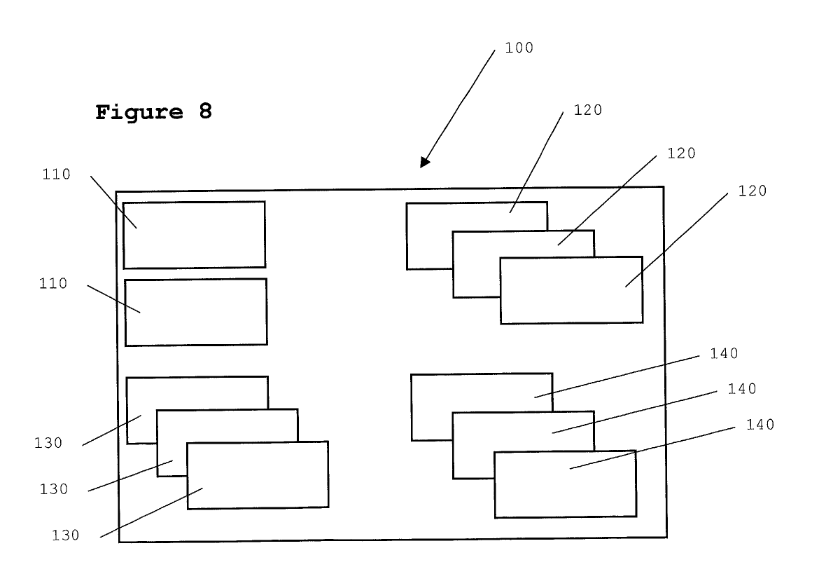

FIG. 8 is a schematic diagram of a preferred container software application architecture;

FIG. 9 is a flowchart of a method for printing documents from a self-service kiosk; and

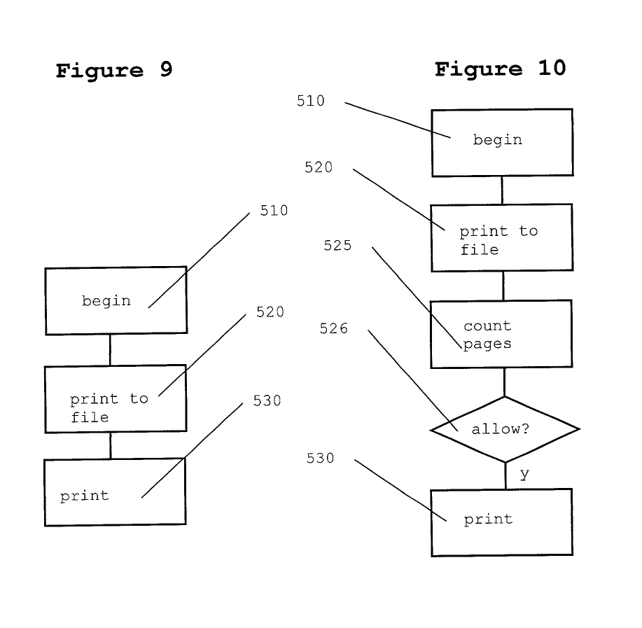

FIG. 10 is a flowchart of an alternative method for printing documents from a self-service kiosk;

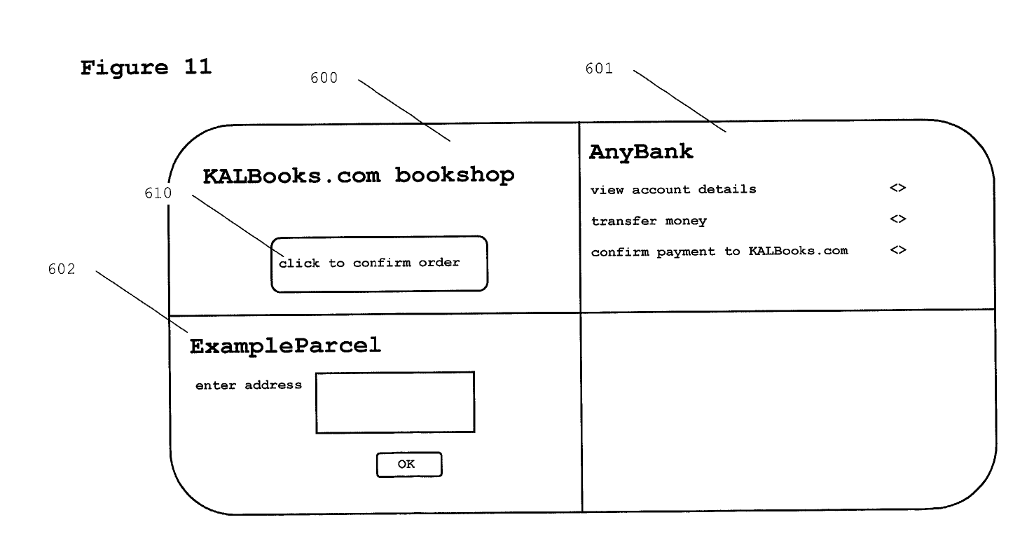

FIG. 11 represents a screen display of a compound transaction; and

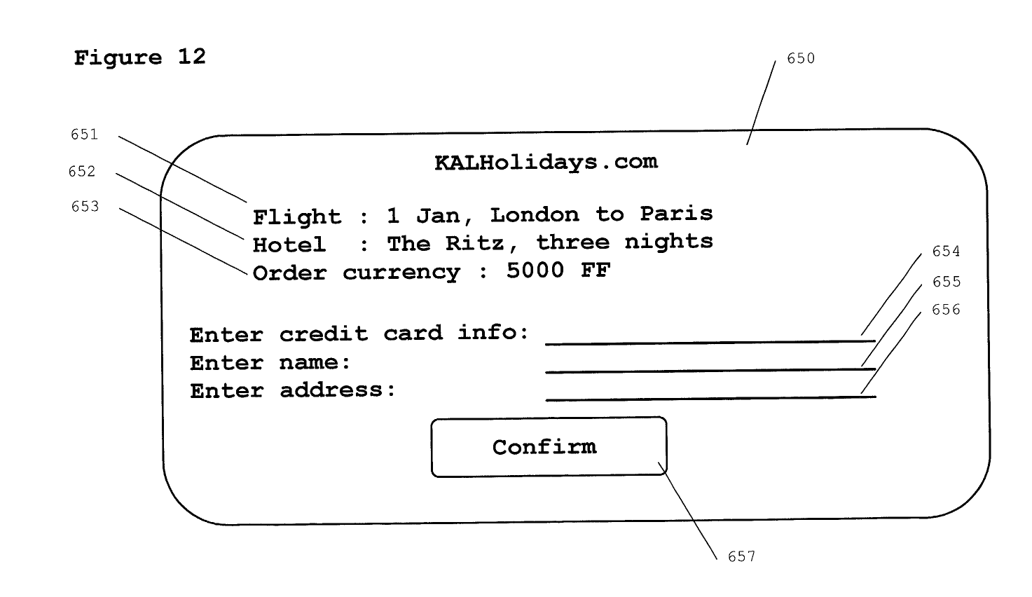

FIG. 12 represents a screen display of a further example compound transaction.

Architecture

FIG. 1 illustrates a kiosk 1 having a display 2 driven by a computer 10 which has access to one or more servers 3 across a network 4. Kiosks have user interfaces for interaction with users 5. User interfaces may incorporate devices such as monitors, touch screens, keyboards, mice, cash dispensers, card reading devices, identification devices such as number pads for inputting a PIN number or cornea, iris or finger print readers.

The system is particularly beneficial in the case where the computer 10 is connected to the internet and has the potential to access a large range of servers, but the owner of the kiosk wishes to customise the functionality provided by some web servers or restrict access to a subset of such servers under some or all circumstances.

FIG. 2 illustrates the architecture of software according to one aspect of the present invention. A container application 100 comprises one or more browser components 110 for accessing information from the internet and one or more site agent components 120 for providing customised functionality for particular uses of the kiosk.

In the preferred embodiment, the container application 100 maintains an object model including all browser components 110, site agent components 120 and also user interface 130 and transaction components 140 discussed below. Therefore, any component may communicate with any other through the object model.

Typically, a browser component 110 has the capacity to access the internet and download information. It will typically also have the capacity to display web pages on screen 2. Typically, the browser component 110 will be Internet Explorer® component from Microsoft®.

Site agents adapt the way in which the computer 10 interacts with the web server 3 and user 5. Different site agents are provided for different web applications.

Site agent components 120 will typically be implemented in a scripting language and Microsoft® Script Host™ may be incorporated to enable a variety of scripting languages to be used. Alternatively, the site agent components 120 can be written in any standard programming language and precompiled site agent components 120 can be loaded by the container application 100 on demand. Site agent components 120 can be preinstalled on a kiosk or can be downloaded from one or more remote servers 3 when required.

Browser and site agent components may be separate components within the container application 100 or, alternatively, one may be contained within the other. For example, each site agent component 120 may have one or more browser components 110 therein or vice versa. Other configurations will be apparent to one skilled in the art.

Selection of Site Agents

A site agent 120 is one way of implementing a document altering module. A simple document altering module which acts simply with reference to a series of rules specifying actions and the events which trigger those actions is discussed below.

A site agent component 120 is triggered depending on one or more rules. For example, a kiosk 1 might have one site agent for use when accessing a particular server used by a bank and thereby providing functionality which is customised for the web application provided on that server. The same kiosk 1 may have a second site agent for use with an airline ticketing server and provide different functionality when that server is accessed.

For example, FIG. 3 illustrates a configuration where there is provided one or more data structures referred to as sitesets 200. A siteset 200 is selected in response to user interaction with the kiosk. Typically, a siteset will have at least an identifier 201, an initial address 202 in the form of a uniform resource locator (URL), one or more allowed address rules 203 and one or more site agent pointer 204 pointing to one or more site agent components 120 associated with that siteset. A siteset control 150 within the container application 100 activates customisations specified by sitesets 200. The siteset control 150 provides methods such as a method to jump to a siteset, sneding a browser to the specified initial address 202 and starting up any specified site agent pointer 204.

A siteset 200 is typically selected in response to a trigger such as a user 5 selecting a menu item. A default siteset is activated initially, specifying an initial web page, initial site agent etc. The default siteset is reactivated after a timeout due to a user not carrying out any action for predetermined period of time.

A browser component 110 is instructed to access the initial address 202. Thereafter, access by the user to web pages is restricted to those allowed by the address rules 203. An example address rule 203 would be to allow access to all web sites on a particular web server and no other sites. In this example, a rule 203 comprises a group of URLs, using wildcards to define a group in a single statement, for example, http://www.kal.com/* for all sites on www.kal.com. Use of wildcards enables types of document to be specified, for example http://*/*.exe defines all executable files and enables a rule to specify customisations depending on file type. For example, access to all executable files could be disallowed.

A particular site agent indicated by the site agent pointer 204 is then started up. More than one site agent 120 may be activated at once and each may be associated with a browser component 110. For example, multiple web sites may be displayed at the same time by multiple browser components 110 with each being associated with a different site agent component 120.

Partitioning the Internet

The use of sitesets allows the internet to appear to a user of the kiosk as if it is partitioned. Particular functionality, determined by rules or site agents 120 specified in a siteset 200 is activated when a user accesses the subset of internet pages to which the siteset 200 pertains. This particular functionality can be accessed in response to a user requesting a particular siteset or may be activated automatically when a user browses to a location within the siteset. In another embodiment, the user is unable to leave the pages specified by the siteset until a specified procedure has been completed.

Required Devices and Required Pages

A siteset 200 may specify devices or web pages required to enable the siteset to be accessed. A site agent 120 may also require such a device or web page in order to function.

Here, the kiosk checks whether a certain hardware device is functioning correctly or whether a certain web page is available. If a required device is unavailable or a required web page is unavailable the siteset or site agent is not activated. A siteset or site agent may specify alternative actions to be carried out should a required device or required web site not be available.

As well as merely checking that a device or web site is available, the siteset or site agent may also check specified properties of the device or information returned in a web page to decide whether to allow the site set or site agent to be activated.

An important function of site agents is to make modifications to the user interface presented to a user once a web page has been downloaded. Preferably, this is carried out using event driven programming. The container application 100 will ensure that the site agent is operative before the page is downloaded and the container application 100 has a module which activates one or more site agents 120. If sitesets are used, the site agent will be loaded when the container application 100 moves to the new siteset. An alternative implementation might load the site agent when it detects navigation to a web page that the agent is associated with. In both cases, the browser signals the container application 100 when the page is downloaded, and the container application 100 passes control to the site agent prior to displaying the page. Alternatively the web page is displayed and the site agent is then called whereupon it amends the page and the browser updates the displayed page.

Once a browser component 110 has downloaded a web page, a site agent 120 can then examine and, if required, alter the web page before it is displayed or take another predetermined action such as deleting executable script inappropriate to a kiosk. Examples of inappropriate script include defining stylesheets incompatible with the kiosk display or calls to methods requiring peripherals not found on a kiosk. Changes can be implemented by editing the script, or its document object model where relevant (see below). Changes to the visual presentation of a web site may include operations such as magnifying small details, deleting or customising logos, altering style sheets and other document properties, removing components judged inappropriate for kiosk use such as the ability to search the entire internet from the downloaded page.

For example, the browser component 110 can parse the web page into an object model according to an appropriate Document Object Model (DOM) such as the HTML or DHTML document object models described in standards available from Microsoft® or the World-Wide Web Consortium. The site agent 120 may then alter the object model before the web page is displayed.

However, alterations to the visual presentation are not limited to merely altering the downloaded web page. In another embodiment a web page is downloaded and a site agent component causes a different web page to be displayed. Multiple different user interfaces may be layered and a particular interface selected. This enables a different web page to be displayed to that intended by the provider of a web site or provides a mechanism to readily provide displays in an alternative language.

FIG. 4 depicts an example of site agent operation. In this embodiment a web page is downloaded 225 from a server 3 by a first browser component 110. In the depicted example the web page is a form requiring completion of credit card details to pay for a series of previously selected purchases.

If the kiosk has direct access to a card reader, the site agent recognises 226 that alternative functionality is appropriate. For example, the form may require alphanumeric input of credit card authorisation details and the kiosk may have a credit card reader but no keyboard. Therefore, the best way for a user to enter their credit card details would be using the credit card reader provided as a peripheral on the kiosk. The site agent thus displays an alternative image saying “Swipe credit card” 227. The alternative image may be stored locally in the kiosk or preferably be loaded from a remote web site. This alternative image is shown and the downloaded web page hidden. Alternatively, the site agent may cause a second browser component to acquire and display the alternative image on top of, and thereby hiding, the web page display region of the first browser component.

The user's credit card details are then acquired 228 by the credit card reader whereupon the site agent 120 then causes these details to be submitted to the server 3. The downloaded web page will typically have contained an electronic form to be completed by the user for submission to a server. The site agent 120 may electronically complete 229 this form (i.e. prepare an appropriate data record) using the information it has received from the credit card reader and cause the form to be submitted to the server 230. The site agent then allows the next web page downloaded to be displayed in the normal manner 231.

Whereas altering the web page offers a wide latitude of modifications, the functionality of the site agent is preferably further enhanced by the capacity to ‘call’, or cause the execution of other software components and functions. Some such callable functions may activate and/or communicate with hardware components.

Such hardware devices may be attached to the kiosk. For example, a site agent may use a kiosk peripheral such as a touch screen, a cash dispenser or a card reader to either cause particular hardware events to occur or to receive information (e.g. credit card details). This may be done directly or through software device driver components. Alternatively, the hardware device may be remotely operated such as a remote printer.

A site agent may also use network access to carry out network functions, sending and requesting information.

For example, a site agent might complete and submit an electronic form or activate (also known as ‘drive’) a particular web site, for example by making particular HTTP requests and extracting information from the resulting downloaded web pages. As well as just extracting information, remote web servers which provide functionality that depends on a user's previous requests can be brought to a particular state by performing said requests.

Such requests can be made by means of a browser component which is not displayed on the screen.

Examples include: (1) sending status to a monitoring application implemented as a web site (2) a combined shopping cart for a set of e-commerce sites, with the agent filling in the details of each site as necessary. In this combined transaction scenario a site agent may drive remote web sites without displaying them to the user.

Triggering Agent Actions

Site agents may function as linear applications or be event driven. Typically, a site agent will be notified by the container application whenever a navigation event occurs within a browser component associated with that site agent. However, events may be generated by other sources as well.

The following are but several examples of events the site agent may be programmed to respond to:

downloading of a page from a specified URL.

downloading of a page containing a particular identifier. For example, a site agent may perform a function in response to a web page containing a particular meta-tag or password.

a predetermined amount of time having passed—for example the time the user has spent using the kiosk.

an event driven by another site agent, for example a site agent which calculates a user's bill for using the kiosk.

a user triggered event, such as pressing a particular button.

Site agents are preferably activatable; they can either be in activated or non-activated states and can be switched between the two by the container application, e.g. in response to user selection of a particular application from a menu.

Rule-Based Implementation

Alternatively to using activatable site agents, the alteration of a document or carrying out of additional functionality may be carried out by a document altering module and/or function executing agent module which simply implements a series of rules without requiring activation.

For example, such an agent module might scan each downloaded page and replace graphics in certain pages or increase font sizes which are below a size specified by a rule.

Rules are event driven. Typically, a rule will be triggered by the container application whenever a navigation event occurs within a browser component associated with that site agent. Rules essentially consist of directives to be performed when particular activating conditions are met.

Example activating conditions that might cause rules to perform directed functions include:

downloading of a page from a specified URL.

downloading of a page containing a particular identifier. For example, a rule may perform a function in response to a web page containing a particular meta-tag or password.

a predetermined amount of time having passed—for example the time the user has spent using the kiosk.

an event driven by another site agent, for example a site agent which calculates a user's bill for using the kiosk.

a user triggered event, such as pressing a particular button.

Rules will typically be implemented as pairs of activation conditions and directives. The activation conditions will encode a trigger event of the sort listed above, and the directive may specify any suitable functionality. Rules may be written as text and interpreted by the container application, or written in some suitable programming language and interpreted by the container application, or compiled to a suitable binary form for adding functionality to the container application. Rules can be preinstalled on a kiosk or can be downloaded from one or more remote servers when required.

For convenience, rules may be grouped in rule sets. An implementation that uses sitesets might associate a rule set with each siteset. Rule sets could be downloaded separately from a server.

An important, albeit not necessary, function of rules is to make modifications to the user interface presented to a user once a web page has been downloaded.

For example, once a browser component has downloaded a web page, rules may comprise a directive to alter the web page before it is displayed. The browser component can parse the web page into an object model according to an appropriate Document Object Model (DOM) such as the HTML or DHTML document object models described in standards available from Microsoft® or the World-Wide Web Consortium. A directive may then alter the object model before the web page is displayed.

Example changes to the visual presentation of a web site would be to magnify small details, delete or customise logos, alter style sheets and other document properties, remove components not judged appropriate for kiosk use such as the ability to search the entire internet from the downloaded page.

However, alterations to the visual presentation are not limited to merely altering the downloaded web page. In another embodiment a web page is downloaded and a rule activated by download may direct that a different web site is displayed. Multiple different user interfaces may be layered and a particular interface selected.

A rule may also direct that alternative functionality to that provided on the web page is appropriate. For example, the kiosk may have a credit card reader but no keyboard. Therefore, the best way for a user to enter their credit card details would be using the credit card reader provided as a peripheral on the kiosk. Example card readers include the KD Electronics CIM4900, the Mag-Tek MT215 and the Omron 3S4YR-MVFW. A rule may cause the container application to display an alternative image to show the user, for example a different HTML script stored within the computer or downloaded from another web site and saying “Swipe credit card” 227. This alternative image is shown and the downloaded web page hidden. For example, the rule may instruct the container application to instruct a second browser component to acquire and display the alternative image on top of, and thereby hiding, the web page display region of the first browser component. Further rules can then direct the container application to input the data from the credit card in specific fields in the web form.

Combining Site Agents and Rules.

Rules need an interpreter to perform the actions they specify. In one embodiment this interpreter is the container application 100. Another possible embodiment is for the container application 100 to be extended with site agents as described above, and for one or more of those site agents to use rules to configure their behaviour. Other possibilities include making the browser components or the transaction components use rules to customise their behaviour. Yet more possibilities will be apparent to those skilled in the art.

Rules may also control how the container application uses network access to carry out network functions, sending and requesting information.

For example, one group of rules might direct the completion and submission of an electronic form or drive a particular web site, for example by making particular HTTP requests and extracting information from the resulting downloaded web pages in response to the specified triggers. As well as just extracting information, remote web servers which provide functionality that depends on a user's previous requests can be driven by performing said requests.

Such requests can be made by means of a browser component which is not displayed on the screen.

Layouts and User Interface Components

FIG. 5 illustrates another, embodiment of the present invention in which there are further provided one or more user interface components 130. User interface components 130 are typically implemented as ActiveX® controls, JavaBeans® or the like, or they may use functionality built-in to the container application, such as specifying an area of screen to act as a button (or generate an event when touched by the user). The user interface component may also interface with various services provided by the operating system.

User interface components 130 function to provide visual images and information to users when required. Properties, such as whether or not they are visible at a particular time, can be altered by site agents 120, rule-based agents or other software components. User interface components 130 can provide events and communicate with other components in response to user interaction. For example, a user interface component may be a banner for a particular service. When the banner is selected by a user, information stored in a siteset may be used to access a particular service.

User interface components may be activated responsive to site agents, a rule-based agent module or instructions within web pages.

FIG. 6 shows an improved siteset 300. Said siteset is as previously described with the addition of layout information 310 describing how displayed components should be laid out, including the number, locations and size of browser and user interface components. Thus one function of the siteset is to dictate the visual appearance of a downloaded web page.

FIG. 7 illustrates an example screen view 400. A browser component provides a visible web content windows 401. User interface components provide for example, a banner 402 which, if selected, provides a hyperlink to a web site. User interface components may include all types of information delivered through the internet such as streamed video or audio or, as provided in this example, an animation 403. User interface components 404, 405, 406 may link to specific application by triggering sitesets 200 as described elsewhere herein.

Transaction Processing Components

In FIG. 8 a preferred embodiment is shown in which there are provided an extensible library of transaction processing components 140. Transaction processing components 140 provide methods for completing hardware dependent tasks; for example, a single transaction processing component 140 might control ejecting a credit card, identifying a user from a fingerprint or carrying out complex protocols such as seeking authorisation for a financial transaction.

Transaction processing components 140 can be accessed either directly from web page script executed within a browser component 110 or from other components. Transaction processing components 140 implement access to and interaction with hardware devices. In one embodiment these are OPOS Controls as described in the OPOS specification or Kalignite® controls as provided by Korala Associates Limited, Edinburgh, Scotland.

A transaction processing component 140 may use browser components 110 to access particular web pages or provide input/output functionality. For example, to download and display a web page stating that cash is being counted.

Compound Transactions

An aspect of the present invention provides for a conditional completion of a group of transactions. Thus, the set of transactions, or a ‘compound transaction’, are interdependent and only come to completion if a certain set of conditions is met, e.g. the successful completion of each member of a predetermined set of transactions.

FIG. 11 illustrates a screen shot of a first example of the present invention being used to implement a compound transaction. In this system, a transaction can be defined which requires the user to carry out multiple network interactions before it can be authorised. For example, a user might select a book from a bookseller web site, browse to select a parcel carrier from a separate web site belonging to the parcel carrier and browse to authorise payment, for example from a banking web site. The transaction of purchasing the book can only take place once the parcel carrier and payment method have been established.

In this first example, a compound transaction control module is provided. This module is preferably a site agent 110 but could equally well be part of the container application 100. Firstly, multiple web pages 600, 601, 602 are displayed 650. A button 610 is to be selected by a user to complete a transaction (here, the purchase of a book) but the web page 600 displaying the button 650 is amended by the compound transaction control module after download and before display to disable the button. Responsive to subsequent events, the compound transaction control module then detects that information has been received indicating individual parts of a transaction have been completed. In this example, it detects that browser module 601 has accessed a web page known by its address to be displayed only when a payment has been confirmed and that browser module 602 has returned a page known by a meta-tag contained within the page to indicate that a parcel delivery company has been booked. Once completion of all the parts of the transaction are completed, web page 600 is amended again, activating the button 610. The user may now complete the compound transaction by selecting the button 610 which triggers an HTTP request through conventional browser technology.

In a second example, the compound transaction control module causes multiple web pages to be displayed in separate browser components. A button is disabled in one window as before and only reactivated when the compound transaction control module detects that each browser component has navigated to a preset page known to be displayed at the end of a particular transaction.

A third example is illustrated in FIG. 12. Here a web page is displayed in a browser window 650, the function of which is to enable a user to make multiple bookings and payments, in this case a flight 651, a hotel 652 and ordering currency 653. The user is prompted to enter information concerning their credit card number 654, name 655 and address 656. The user then selects a button 657, responsive to which the compound transaction control module instructs one or more browser modules to retrieve booking web pages relating to the flight, hotel and currency ordering from separate servers belonging to flight, hotel and currency companies. The compound transaction control module then completes form information on each of these web pages using the name, address and credit card information supplied and returns it to the relevant server, thereby booking a flight, hotel and currency. The compound transaction control module then monitors the web page returned by the flight, hotel and currency companies' servers, extracts information required to decide whether each of the bookings was processed successfully from the address or content of the returned web pages and then directs the main browser window 650 to one of two preset web addresses, depending on whether the three separate transactions complete correctly.

In a fourth example, a compound transaction control module has a list of web addresses stored. A first web page is downloaded. Each link within that web page which links to a web address not in the list is disabled. The web page is then displayed. As a user navigates between pages, the compound transaction module monitors which addresses the user has visited and, for each page, again disables links to web addresses not in the list. When the compound transaction module detects that each web address on the list has been visited, the compound transaction module navigates to another pre-set page. This enables a transaction to be defined requiring a user to visit each of a number of web pages specified in the list.

Features from these four examples may be combined in different permutations. In general, a compound transaction control module on the computer can be initiated either by user selection of the particular transaction or in response to the user browsing to a particular known web address, or in response to information contained within a web site. A compound transaction control module may then cause other web sites which are related to other parts of the compound transaction to be displayed. This may be done within a different window of the same browser, by customising the browser to display multiple web sites next to each other or by activating multiple browser components or multiple windows within the same component.

The compound transaction control module may guide the user through a sequence of web pages from the various sites by navigating a single browser from page to page or by using one browser per web-site and controlling which browsers are displayed. Remote web sites may be driven by providing one browser per web-site to access the remote sites but not actually displaying any of the browsers; instead the display would be another browser showing one web page. The main browser would gather information from the user and the secondary browsers, and pass on the necessary subset of this information to each secondary browser to send to its web site. Driving of remote web sites is discussed further above.

Typically, the compound transaction control module does not authorise a specified transaction until it has established that other preset tasks have been completed. A compound transaction control module might require tasks to be completed in a specified order. The completion of tasks is typically monitored by receiving web sites of specified address or containing specific information from a remote server; however, the compound transaction control module could equally detection completion of tasks by monitoring user actions, such as selecting buttons.

The compound transaction control module typically activates a transaction by sending a request to a server or by activating a means for allowing the user to activate the transaction, for example, by allowing them to select a link which was previously disallowed.

A compound transaction control module can be a site agent 110, specified in a siteset or could equally well be a part of the container application 100. Accessing a particular siteset can trigger a particular compound transaction control module. Compound transaction control modules can also be downloaded on demand from servers.

Branding

One use of the agent or rule-based document altering module is to provide a means for branding sections of the internet It is generally desirable to be able to apply uniform branding to a section of a companies web site. Furthermore, many web-sites on the internet provide links to material supplied by third parties and it is desirable to find a way to ensure that a person browsing those third party sites associates them with the referring party. This is current achieved in two main ways. Firstly, frames can be used to show a linked site within a broader frame from the referring parties web page. This works but clutters the screen up and users will often return to the links site in the future with no reminder of how they first reached it. Secondly, new web pages are written which have co-branding to ensure that user's know that they were referred to a particular service by another party.

However, the document altering module of the present invention can be used to make alterations to sites without resorting to either of these approaches. For example, on browsing to a companies web site, a site agent can adapt each downloaded page to add some branding. This might consist in altering some graphics, HTML stylesheets, adding logos, watermarked pictures etc. Furthermore, it may continue to provide such branding even when the user leaves the companies web site. For example, a site agent can be activated at a first company's web site then, when a user links to a second company's web site it will continue to display the first company's branding thereby showing a link between the firms. Similarly activation of multiple site agents allows multiple branding to be provided at once. As well as being activated by site agents, branding elements can be implemented by the container application implementing specified rules.

A branding site agent may act not just to alter the visual appearance of downloaded web pages but to carry out other functions, such as guiding a user through a web site or reporting usage of the web site as will be apparent from the discussion of site agent's above. Furthermore, it may place additional images around the screen or start up additional functionality. For example, it may open separate browsers or display user interface components.

Such site agents may be downloaded from a particular web site or preinstalled in a computer. They may be limited to functioning only within web addresses specified in a siteset or they may persist for at least the remainder of the user's browsing session. A single branding site agent may be used with multiple sitesets.

Additional Alternatives

As well as being used to display web pages, the present invention can be used in a kiosk for displaying any form of browsable hyperlinked document downloadable across a network. Typically, such hyperlinked documents are provided in the form of separate pages having individual addresses. Documents may comprise both data, particularly data specifying a visual display, and executable instructions or script.

The preferred embodiment of hyperlinked information downloadable across a network is web pages in the form of HTML, XML or Dynamic HTML documents sent or received by means of the well-known HTTP protocol.

The invention extends to computer programs in the form of source code, object code, code intermediate sources and object code (such as in a partially compiled form), or in any other form suitable for use in the implementation of the invention. Computer programs may be standalone applications, software components or plug-ins to other applications. Computer programs may be web pages. Computer programs may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for download across the internet from a server. Computer programs may also be embedded in an integrated circuit.

Where the term credit card is used, it will be recognised by one skilled in the art that the same use may be made of a debit card, electronic cash card, electronic payment card, electronic wallet or personal identifier device.

A reference to a web page being executed refers to it being rendered for display on a screen and/or executed as a script. Execution of a web page typically includes parsing it into a document object model.

Different features discussed in this application may be combined in different combinations to those explicitly stated.

Section headings are provided for the purposes of clarity only and are not limiting.

Further modifications and alterations may be made within the scope of the invention herein disclosed.

What is claimed is:

1. A control program comprising:
a document retrieving module for retrieving hyperlinked documents, the documents comprising graphical image data or instructions;
at least one document altering module adapted to alter an accessed document responsive to accessing of said document;
a document executing module for rendering a visual display or executing instructions according to said altered document;
wherein said control program is controlling at least part of the operation of a self-service kiosk.

2. The control program of claim 1 further comprising a plurality of document content alteration directives, each having at least one activation condition associated therewith; wherein the document altering module is adapted to alter said document responsive to one or more of said document content alteration directives when at least one activation condition is fulfilled.

3. The control program of claim 2 wherein the activation conditions are selected from a group consisting of downloading of a page with a specified URL, downloading of a page containing a specific script, text segment, tag or meta-tag, a predetermined amount of time having passed, an event generated by a container application, an event generated by a site agent, a user-input event.

4. The control program of claim 1 adapted to selectively activate one or more document altering modules, said document altering modules only altering documents once the document altering module is activated.

5. The control program of claim 1 adapted to notify a document altering module when a document has been retrieved and thereby cause the document altering module to alter the document.

6. The control program of claim 1 wherein a document altering module is adapted to add, remove or change instructions in the document which, when executed by the document executing module, cause the computer to perform an action selected from a group consisting of:
accessing a user interface hardware device;
sending information to a server across a network;
receiving information from a server across a network; and
receiving authorisation to allow a transaction from a transaction authorising server.

7. The control program of claim 1 wherein a document altering module comprises program code to cause the computer to perform an action selected from a group consisting of:
accessing a user interface hardware device;
sending information to a server across a network;
receiving information from a server across a network; and
receiving authorisation to allow a transaction from a transaction authorising server.

8. The control program of claim 1 wherein a document altering module alters a document to prevent a function from being executed until at least one specified event has occurred.

9. The control program of claim 8 wherein a document is altered to disable a button until at least one specified event has occurred.

10. The control program of claim 8 wherein a document is altered to disable a hyperlink to another document until at least one specified event has occurred.

11. The control program of claim 8 wherein a specified event is the receipt of specified information from a server.

12. The control program of claim 11 wherein a specified event is the receipt of specified information from a server indicating the user has completed a transaction.

13. The control program of claim 11 wherein specified information from a server is a particular web page or a web page comprising particular information.

14. The control program of claim 11 adapted to direct one or more browser components to retrieve addressed documents which direct a user to carry out a particular action responsive to which a server transmits the specified information.

15. The control program of claim 1 adapted to access a list of addressed documents and to alter each addressed document to only link to other documents on said list, wherein the control program detects a user access to each addressed document on said list and carries out a predetermined function responsive to at least said detection.

16. The control program of claim 15 wherein the function responsive to said detection is retrieval of a specified document.

17. The control program of claim 1 further comprising one or more transaction components providing methods for carrying out a hardware function.

18. The control program of claim 1 wherein a document is a web page.

19. The control program of claim 18 wherein the document retrieving module and the document executing module are both part of a web browser.

20. The control program of claim 18 adapted to parse a downloaded web page into a document object model, wherein the document altering module alters the document object model.

21. The control program of claim 20 which maintains an object model comprising a web browser component, a document altering module and a document object model of a downloaded web page.

22. The control program of claim 1 wherein a document altering module is adapted to display a different image or execute different instructions to the web page.

23. The control program of claim 22 wherein the document altering module displays a different image by a browser component overlaying an alternative image over a displayed web page.

24. The control program of claim 22 wherein the document altering module displays a different image by displaying the retrieved web page and also additional visual elements.

25. The control program of claim 24 wherein additional visual elements comprise branding.

26. The control program of claim 1 wherein a plurality of document altering modules alter an accessed document.

27. The control program of claim 1 adapted to add branding to one or more web pages.

28. The control program of claim 25 adapted to add branding to one or more web pages after a user has visited one or more specified web pages.

29. The control program of claim 1 wherein a document altering module is activated in response to a user visiting a web page or one of a plurality of web pages and the document altering module alters subsequently retrieved web pages.

30. The control program of claim 28 altering specified subsequent web pages.

31. A method of implementing a user interface on a self-service kiosk in conjunction with hyperlinked documents retrievable from a data store, the documents comprising renderable display information or executable instructions, the invention comprising the steps of:
retrieving a document from a data store;
calling a document altering module which alters the document;
rendering or executing the document.

32. The method of claim 31 wherein the document altering module is adapted to alter said document responsive to one or more web content alteration directives when at least one activation condition is fulfilled, said one or more web content alteration directives being selected from a plurality of web content alteration directives, each having at least one activation condition associated therewith

33. The method of claim 31 wherein the activation conditions are selected from a group consisting of downloading of a page with a specified URL, downloading of a page containing a specific script, text segment, tag or meta-tag, a predetermined amount of time having passed, an event generated by the container, an event generated by a site agent, a user-input event.

34. The method of claim 33 comprising the step of selectively activating one or more document altering modules, said document altering modules only altering documents once activated.

35. The method of claim 31 comprising the step of notifying a document altering module when a document has been retrieved and thereby causing the document altering module to alter the document.

36. The method of claim 31 wherein a document altering module is adapted to add, remove or change instructions in the document which, when executed by the document executing module, cause the computer to perform a function selected from a group consisting of:
accessing a user interface hardware device;
sending information to a server across a network;
receiving information from a server across a network; and
receiving authorisation to allow a transaction from a transaction authorising server.

37. The method of claim 31 wherein a document altering module comprises program code to cause the computer to perform a function selected from a group consisting of:
accessing a user interface hardware device;
sending information to a server across a network;
receiving information from a server across a network; and
receiving authorisation to allow a transaction from a transaction authorising server.

38. The method of claim 31 wherein a document altering module alters a document to prevent a function from being executed until at least one specified event has occurred.

39. The method of claim 38 wherein a document is altered to disable a button until at least one specified event has occurred.

40. The method of claim 38 wherein a document is altered to disable a hyperlink to another document until at least one specified event has occurred.

41. The method of claim 38 wherein a specified event is the receipt of specified information from a server.

42. The method of claim 41 wherein a specified event is the receipt of specified information from a server indicating the user has completed a transaction.

43. The method of claim 41 wherein specified information from a server is a particular web page or a web page comprising particular information.

44. The method of claim 41 further comprising the step of directing one or more browser components to retrieve addressed documents which direct a user to carry out a particular action responsive to which a server transmits the specified information.

45. The method of claim 31 further comprising the steps of:
establishing a list of addressed documents;
the document altering module altering each addressed document to only link to other documents on that list; and
carrying out a function responsive to detection that the user has accessed each addressed document in the list.

46. The method of claim 31 wherein the function responsive to said detection is retrieval of a specified document.

47. The method of claim 31 further comprising the step of providing one or more transaction components providing methods for carrying out a hardware function.

48. The method of claim 31 wherein a document is a web page.

49. The method of claim 48 wherein the document retrieving module and the document executing module are both part of a web browser.

50. The method of claim 48 including parsing a downloaded web page into a document object model and the document altering module altering the document object model.

51. The method of claim 50 wherein a container application maintains an object model comprising a web browser component, a document altering module and a document object model of a downloaded web page.

52. The method of claim 31 wherein a document altering module displays a different image or executes different instructions to the web page.

53. The method of claim 52 wherein the document altering module displays a different image by a browser component overlaying an alternative image over a displayed web page.

54. The method of claim 52 wherein the document altering module displays a different image by displaying the retrieved web page and also additional visual elements.

55. The method of claim 54 wherein additional visual elements comprise branding.

56. The method of claim 31 wherein multiple document altering modules alter an accessed document.

57. The method of claim 31 comprising the step of adding branding to one or more web pages.

58. The method of claim 55 comprising the step of adding branding to one or more web pages after a user has visited one or more specified web pages.

59. The method of claim 31 wherein a document altering module is activated in response to a user visiting a web page or one of a plurality of web pages and alters subsequently retrieved web pages.

60. The method of claim 59 altering specified subsequent web pages.

61. The computer readable media having the computer program of claim 1 stored thereon.

62. A computer readable media comprising computer program code means which, when loaded onto a computer, cause it to execute the method of claim 31.

63. A control program comprising:
a document retrieving module for retrieving hyperlinked documents, the documents comprising graphical image data or instructions;
a document executing module for rendering a visual display or executing instructions according to said document;
at least one agent module responsive to retrieving of said document;
wherein said control program is controlling at least part of the operation of a self-service kiosk.

64. The program of claim 63 further comprising a plurality of directives, each having at least one activation condition associated therewith; wherein an agent module is adapted to execute one or more functions responsive to one or more of said directives when at least one activation condition is fulfilled.

65. The program of claim 64 wherein the activation conditions are selected from a group consisting of downloading of a page with a specified URL, downloading of a page containing a specific script, text segment, tag or meta-tag, a predetermined amount of time having passed, an event generated by the container, an event generated by a site agent, a user-input event.

66. The program of claim 63 adapted to selectively activate one or more agent modules, said agent modules operable responsive to retrieval of documents once activated.

67. The program of claim 63 adapted to notify an agent module when a document has been retrieved.

68. The program of claim 63 wherein an agent module is adapted to carry out a function selected from a group consisting of:
accessing a user interface hardware device;
sending information to a server across a network;
receiving information from a server across a network; and
receiving authorisation to allow a transaction from a transaction authorising server.

69. The program of claim 63 wherein an agent module is adapted to carry out a function when at least one specified event has occurred.

70. The program of claim 69 wherein a specified event is the receipt of specified information from a server.

71. The program of claim 70 wherein a specified event is the receipt of specified information from a server indicating the user has completed a transaction.

72. The program of claim 70 wherein specified information from a server is a particular document or a document comprising particular information.

73. The program of claim 69 adapted to direct one or more browser components to retrieve addressed documents which direct a user to carry out a particular action responsive to which the specified event occurs.

74. The program of claim 69 wherein the specified event is detection that the user has viewed or accessed each of a plurality of specified documents.

75. The program of claim 63 wherein an agent module is adapted to activate and instruct one or more separate browser components.

76. The program of claim 63 further comprising one or more transaction components providing methods for carrying out a hardware function.

77. The program of claim 63 wherein a document is a web page.

78. The program of claim 77 wherein the document retrieving module and the document executing module are both part of a web browser.

79. The program of claim 78 which maintains an object model comprising a web browser component, a document altering module and a document object model of a downloaded web page.

80. The program of claim 63 wherein a agent module is adapted to display a different image or execute different instructions to the web page.

81. The program of claim 80 wherein the document altering module displays a different image by a browser component overlaying an alternative image over a displayed web page.

82. The program of claim 63 wherein the agent module causes one or more further software components to be activated.

83. The program of claim 82 wherein further software components provide visual images.

84. The program of claim 83 wherein further software components provide branding.

85. The program of claim 67 wherein an agent module is activated in response to a user visiting a web page or one of a plurality of web pages and carries out functions responsive to retrieval of subsequent web pages.

86. The program of claim 85 responsive to retrieval of specified subsequent web pages.

87. A method of implementing a user interface on a self-service kiosk in conjunction with hyperlinked documents retrievable from a data store, the documents comprising renderable display information or executable instructions, the method comprising the steps of:
retrieving a document from a data store;
activating an agent module responsive to retrieval of the document; and
rendering or executing the document.

88. The method of claim 87 wherein an agent module executed one or more functions responsive to one or more directives when at least one activation condition is fulfilled, said one or more directives being from a plurality of directives, each having at least one activation condition associated therewith.

89. The method of claim 88 wherein the activation conditions are selected from a group consisting of downloading of a page with a specified URL, downloading of a page containing a specific script, text segment, tag or meta-tag, a predetermined amount of time having passed, an event generated by the container, an event generated by a site agent, a user-input event.

90. The method of claim 87 comprising the step of selectively activating one or more agent modules, said agent modules operable responsive to retrieval of documents once activated.

91. The method of claim 87 comprising the step of notifying an agent module when a document has been retrieved.

92. The method of claim 87 wherein an agent module carries out a function selected from a group consisting of:
accessing a user interface hardware device;
sending information to a server across a network;
receiving information from a server across a network; and
receiving authorisation to allow a transaction from a transaction authorising server.

93. The method of claim 87 wherein an agent module is adapted to carry out a function when at least one specified event has occurred.

94. The method of claim 93 wherein a specified event is the receipt of specified information from a server.

95. The method of claim 94 wherein a specified event is the receipt of specified information from a server indicating the user has completed a transaction.

96. The method of claim 94 wherein specified information from a server is a particular document or a document comprising particular information.

97. The method of claim 93 comprising the step of directing one or more browser components to retrieve addressed documents which direct a user to carry out a particular action responsive to which the specified event occurs.

98. The method of claim 93 wherein the specified event is detection that the user has viewed or accessed each of a plurality of specified documents.

99. The method of claim 87 wherein an agent module activates and instructs one or more separate browser components.

100. The method of claim 87 further comprising the step of activating one or more transaction components providing methods for carrying out a hardware function.

101. The method of claim 87 wherein a document is a web page.

102. The method of claim 101 wherein the document retrieving module and the document executing module are both part of a web browser.

103. The method of claim 102 wherein a container application maintains an object model comprising a web browser component, a document altering module and a document object model of a downloaded web page.

104. The method of claim 87 wherein a agent module is displays a different image or execute different instructions to the web page.

105. The method of claim 104 wherein the document altering module displays a different image by a browser component overlaying an alternative image over a displayed web page.

106. The method of claim 87 wherein the agent module causes one or more further software components to be activated.

107. The method of claim 106 wherein further software components provide visual images.

108. The method of claim 106 wherein further software components provide branding.

109. The method of claim 90 wherein an agent module is activated in response to a user visiting a web page or one of a plurality of web pages and carries out functions responsive to retrieval of subsequently web pages.

110. The method of claim 90 responsive to retrieval of specified subsequent web pages.

111. A computer readable media having the control program of claim 62 stored thereon.

112. A computer readable media comprising computer program code means which, when loaded onto a self-service kiosk, cause it to execute the method of claim 87.

113. A control program comprising:
a web page retrieving module for retrieving web pages;
at least one web page altering module adapted to alter a retrieved web page responsive to retrieval of said web page; and
a web page executing module for rendering said altered web page and executing any instructions in the altered web page;
wherein the document altering module is adapted to alter said web page responsive to one or more web content alteration directives when at least one activation condition is fulfilled;
wherein said control program is controlling at least part of the operation of a self-service kiosk.

114. A control program comprising:
a web page retrieving module for retrieving web pages;
at least one web page altering module adapted to alter a retrieved web page responsive to retrieval of said web page;
a web page executing module for rendering said altered web page and executing any instructions in the altered web page;
wherein the control program is adapted to selectively activate at least one web page altering module, said document altering modules only altering documents once activated;
wherein said control program is controlling at least part of the operation of a self-service kiosk.

115. A control program comprising:
a web page retrieving module for retrieving web pages;
at least one web page altering module adapted to alter a retrieved web page responsive to retrieval of said web page;
a web page executing module for rendering said altered web page and executing any instructions in the altered web page;
wherein the control program is adapted to selectively activate at least one web page altering module, said document altering modules only altering documents once activated;
wherein at least one web page altering module is adapted to alter a retrieved web page to cause said web page executing module to access a user interface hardware device when said altered retrieved web page is rendered;
wherein said control program is controlling at least part of the operation of a self-service kiosk.

116. A control program comprising:
a web page retrieving module for retrieving web pages;
at least one web page altering module adapted to alter a retrieved web page responsive to retrieval of said web page;
a web page executing module for rendering said altered web page and executing any instructions in the altered web page;
wherein the control program is adapted to selectively activate at least one web page altering module, said document altering modules only altering documents once activated;
wherein at least one web page altering module is adapted to alter a retrieved web page to cause said web page executing module to access a server when said altered retrieved web page is rendered;
wherein said control program is controlling at least part of the operation of a self-service kiosk.

117. A control program comprising:
a web page retrieving module for retrieving web pages;
at least one web page altering module adapted to alter a retrieved web page responsive to retrieval of said web page;
a web page executing module for rendering a visual display and executing any instructions in the altered web page;
wherein the control program is adapted to selectively activate at least one web page altering module, said document altering modules only altering documents once activated;
wherein at least one web page altering module is adapted to add branding to retrieved web page before said web page is executed;
wherein said control program is controlling at least part of the operation of a self-service kiosk.

118. A control program comprising:
a web page retrieving module for retrieving web pages;
at least one web page altering module adapted to alter a retrieved web page responsive to retrieval of said web page;
a web page executing module for rendering said altered web page and executing any instructions in the altered web page;
wherein the control program is adapted to selectively activate at least one web page altering module, said document altering modules only altering documents once activated;
wherein at least one web page altering module is adapted to display additional branding on the visual display;
wherein said control program is controlling at least part of the operation of a self-service kiosk.

119. A control program comprising:
a web page retrieving module for retrieving web pages;
at least one web page altering module adapted to alter a retrieved web page responsive to retrieval of said web page;
a web page executing module for rendering said altered web page and executing any instructions in the altered web page;
wherein the control program is adapted to selectively activate at least one web page altering module, said document altering modules only altering documents once activated;
wherein the control program is adapted to initially alter a web page to prevent a specified transaction being completed and to alter the web page to allow said transaction to be completed only when at least one other transaction has been completed;
wherein said control program is controlling at least part of the operation of a self-service kiosk.
